(19) United States
(12) Patent Application Publication
(10) Pub. No.: US 2012/0321757 A1
(43) Pub. Date: Dec. 20, 2012

(54) CELERY HARVESTING FOR PRE-WASHED FULL-LENGTH PETIOLES

(75) Inventor: Terence J. FOLEY, Salinas, CA (US)

(73) Assignee: DOLE FRESH VEGETABLES, INC., Salinas, CA (US)

(21) Appl. No.: 13/161,391

(22) Filed: Jun. 15, 2011

(51) Int. Cl. A23L 1/212; B65D 75/62; A01D 45/00

(52) U.S. Cl. 426/122; 56/327.1; 426/615

(57) ABSTRACT

Celery can be commercially harvested by removing the top portion of the celery plant to leave the bottom portion of the celery plant attached to the stem in the ground. After removing the top portion of the celery, the celery is cut above the stem to separate the plurality of individual petioles. The separated individual petioles are then washed, and packaged into a sleeve. The top portion of the celery plant, the separation of the plurality of individual petioles, as well as the washing of the individual petioles are performed in the field in which the celery plant was grown.

### BACKGROUND

1. Field

The present disclosure relates generally to commercial celery harvesting in the field, and, more particularly, to commercial celery harvesting of pre-washed, full-length celery petioles.

2. Description of Related Art

Celery is commercially sold in two forms: as whole heads for the fresh celery market, or as individual pre-sliced or pre-diced pieces for the processed celery market. Celery sold as a whole head is made up of individual stalks attached at the stem. These whole heads are typically unwashed. Consumers have to detach or cut off the stalks from the stem, and thoroughly wash the stalks before eating. The stem is also typically not eaten, and is discarded. On the other hand, individual pre-sliced or pre-diced celery is typically sold as ready-to-eat celery sticks or sliced/julienned pieces. Individual pre-sliced or pre-diced celery is obtained by further processing the harvested celery plant into smaller pieces.

Conventionally, whole heads for the fresh celery market are commercially harvested manually, and packaged with little or no washing. Manual harvesting is typically employed due to the dirt and mechanical damage that can be caused to the celery head by harvesting machines. Field workers may cut off and discard some of the unwanted debris, such as outer leaves attached to the petioles and any defective portions. The harvested head, which includes the stalks attached at the stem, is then transported to processing stations for washing and packaging.

Commercial harvesting of celery plants for individual pre-sliced or pre-diced celery pieces may be performed by machine. Conventionally, a harvesting machine severs the celery plant at ground level, and transports the harvested celery head to one or more processing stations. At these processing stations, unwanted debris is removed, and the stalks are further processed (e.g., sliced, diced, julienned) into smaller pieces. These celery pieces are typically washed, and then packaged as a ready-to-eat product.

Certain wholesale distributers and retailers desire to commercially sell a fresh market celery product free of unwanted debris, and that maximizes the edible portion of the celery head. Additionally, buyers do not want to pay increasingly expensive freight for non-edible portions of food goods. Furthermore, consumers desire to minimize the amount of work performed and the amount of materials discarded to obtain the edible portions of the celery product purchased.

Currently, the whole heads sold in the fresh celery market do not meet this need since the consumer typically needs to separate the individual stalks of the celery from the stem. Moreover, celery sold as entire heads are typically harder to clean, and contains more dirt and dust. As such, consumers may have to discard more materials to obtain the edible portions, and thoroughly wash the product prior to consumption.

Pre-sliced or pre-diced celery pieces also do not meet this need, since the edible portion of the harvested celery head is not maximized. In slicing the celery stalks prior to packaging, parts of the stalks are discarded to uniformly process the harvested celery head into shorter stalks or smaller sliced/julienned pieces. Moreover, this type of post-harvest processing also incurs additional production costs, e.g., labor costs or additional machinery needed to further process the stalks.

### BRIEF SUMMARY

In one exemplary embodiment, celery can be commercially harvested by removing the top portion of the celery plant to leave the bottom portion of the celery plant attached to the stem in the ground. After removing the top portion of the celery, the celery is cut above the stem to separate the plurality of individual petioles. The separated individual petioles are then washed, and packaged into a sleeve. The top portion of the celery plant, the separation of the plurality of individual petioles, as well as the washing of the individual petioles are performed in the field in which the celery plant was grown.

### DESCRIPTION OF THE FIGURES

The present application can be best understood by reference to the following description taken in conjunction with the accompanying drawing figures, in which like parts may be referred to by like numerals:

FIG. 1 depicts rows of mature celery plant ready to be harvested;

FIG. 2 depicts a single celery plant in the ground;

FIG. 3A depicts an exemplary embodiment of a celery harvesting machine;

FIG. 3B depicts the band saws of the exemplary celery harvesting machine cutting the celery plant in the ground to separate the plurality of individual petioles of the celery plant;

FIG. 4 depicts separated individual petioles on a conveyor belt of the exemplary celery harvesting machine, wherein the separated individual petioles are being transferred to the washing station;

FIG. 5 depicts a washing station of the exemplary celery harvesting machine, wherein the separated individual petioles are washed;

FIG. 6 depicts a packaging station of the exemplary celery harvesting machine, wherein a field worker places a plurality of washed individual petioles through a cone into a celery sleeve; and

FIG. 7 depicts an exemplary package of pre-washed, full-length petioles.

### DETAILED DESCRIPTION

The following description sets forth numerous specific configurations, parameters, and the like. It should be recognized, however, that such description is not intended as a limitation on the scope of the present disclosure, but is instead provided as a description of exemplary embodiments.

The following description relates primarily to the commercial harvesting of celery to obtain pre-washed, full-length petioles that are mechanically harvested and packaged in the field. As used herein, “petioles” refers to the stalks or ribs of a celery plant. As discussed above, commercial celery products are currently sold as whole heads for the fresh celery market, or as individual pre-sliced or pre-diced pieces. When sold as a whole head, the product includes petioles attached at a common stem or base. Consumers have to cut and discard unwanted portions of the celery to separate and obtain the petioles. When sold as processed celery, the petioles are commercially processed into smaller pieces to be sold as shorter sticks or sliced/julienned pieces.

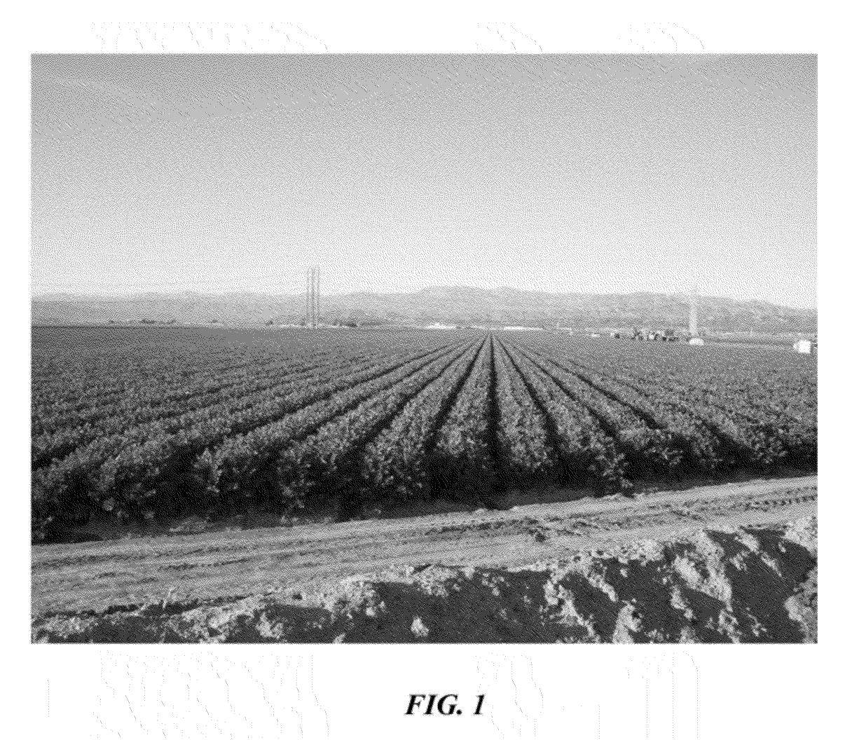

Celery is commercially planted as transplants in rows in a field. Typically, it takes about 85 to 125 days for a celery plant to grow to a size ready to be harvested, approximately 28 to 32 inches in height. FIG. 1 depicts rows of celery plants ready for harvesting.

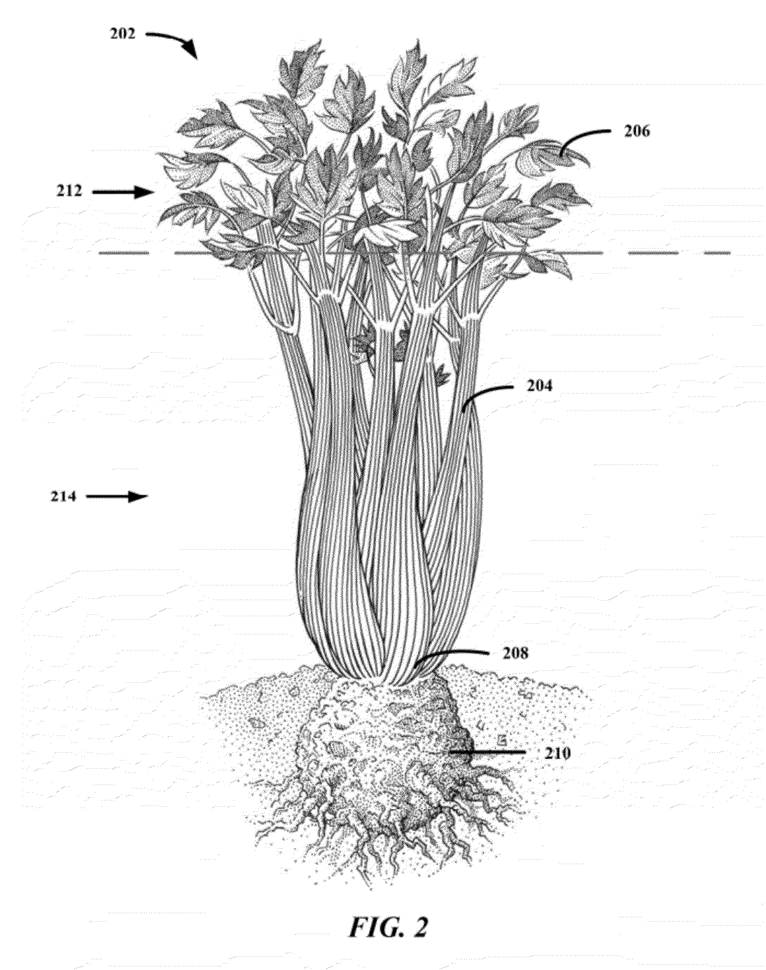

FIG. 2 depicts a single celery plant 202 in the ground that is ready for harvesting. Celery plant 202 includes individual petioles 204, outer leaves 206, stem 208, and root 210. Outer leaves 206 are attached to individual petioles 204. At least a portion of outer leaves 206 make up top portion 212 of the celery plant. Individual petioles 204 are connected at stem 208. Root 210 extends from stem 208 when the celery plant is growing in the field. Root 210, stem 208, and individual petioles 204 make up bottom portion 214 of the celery plant.

As discussed above, whole heads for the fresh celery market are typically harvested manually, whereas celery further processed into individual pre-sliced or pre-diced pieces is typically harvested by machine. The present disclosure provides pre-washed, full-length petioles for the fresh celery market that is harvested by machine.

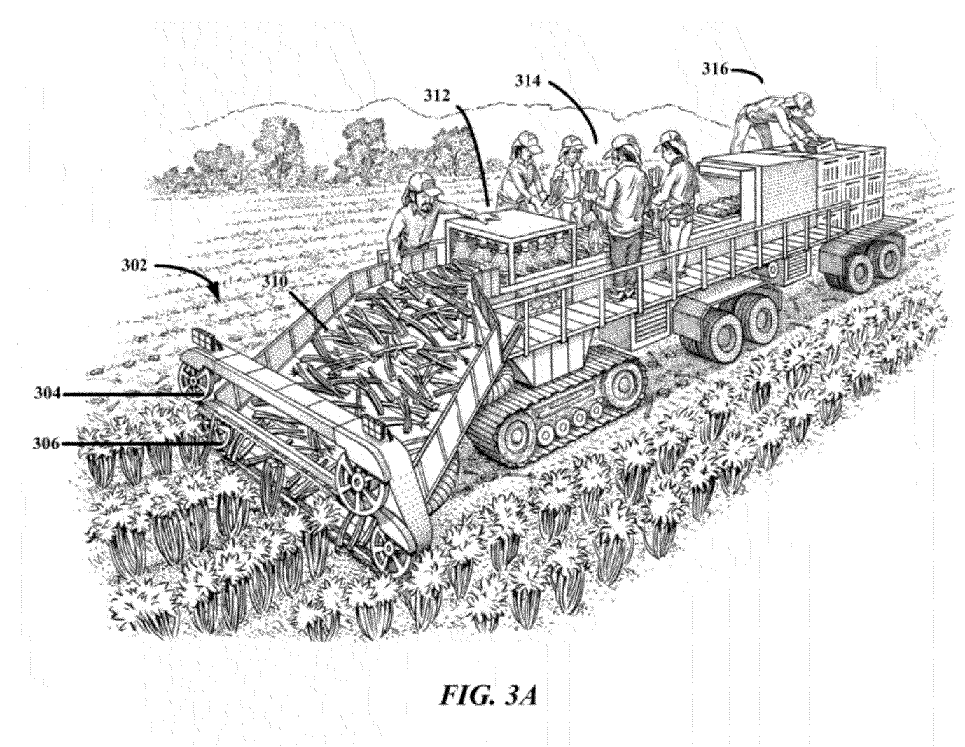

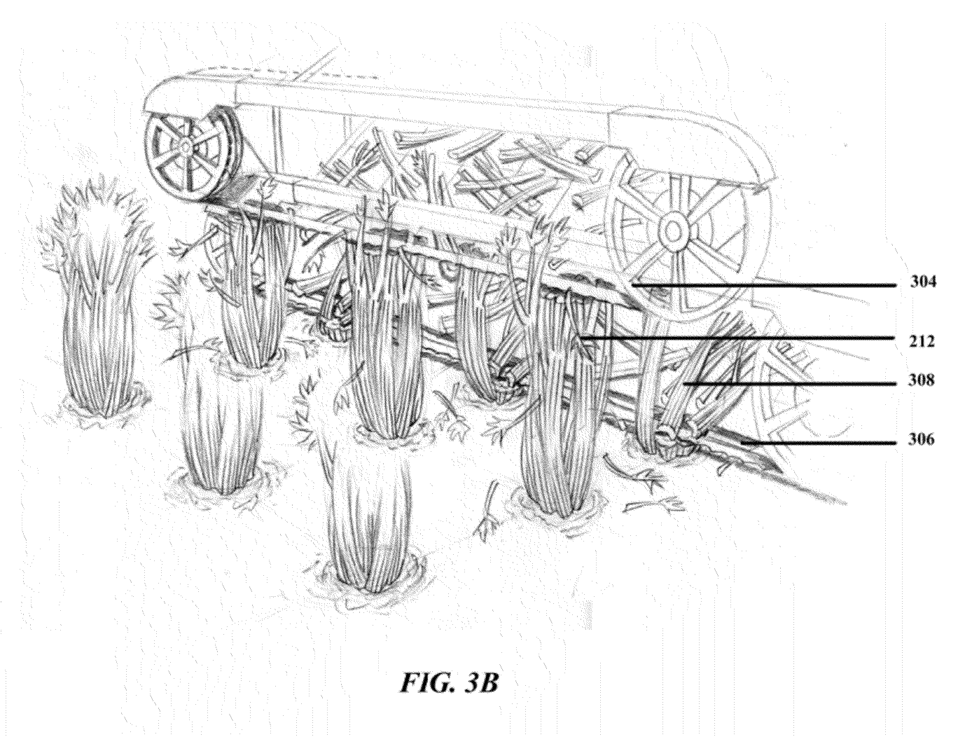

With reference to FIG. 3A, an exemplary harvesting machine 302 is depicted. Harvesting machine 302 includes two band saws (first band saw 304 and second band saw 306). The two band saws are positioned such that first band saw 304 is in front of second band saw 306 as harvesting machine 302 moves forward in the field. In particular, as depicted in FIG. 3B, top portion 212 is cut off using first band saw 304. Removing the top portion of the celery plant leaves the bottom portion of the celery plant attached to the stem and root in the ground. After removing top portion 212, second band saw 306 cuts the celery plant about ½ inch above the ground, causing individual petioles 308 of the celery plant to freely separate. In other exemplary embodiments, the second band saw may be configured to cut the celery plant about ¼ to 1 inch above the ground. It should be understood that the horizontal spacing between first band saw 304 and second band saw 306 may vary, such as by one or more rows of celery, to allow the top portion of the celery plant to fall to the ground.

The individual petioles harvested by harvesting machine 302 maximize the edible portions of the celery plant, and minimize the inedible portions. The individual petioles that freely separate have a length of between 12 and 14 inches. The length of these individual petioles is different from what is currently sold in the market. For example, the standard height of whole heads sold in the fresh celery market is typically 14.5 inches. Individual pre-sliced or pre-diced celery pieces can be of any length typically between 3 and 9 inches, depending on the nature of the further processing (e.g., slicing, dicing).

While band saws 304 and 306 are depicted in FIGS. 3A and 3B, it should be understood that any suitable cutting device may be used to harvest the celery plant. For example, a cutting wheel, a laser beam or a water jet knife may be employed in the process described above. The cutting device may adopt any configuration suitable to cause the top portion of the celery plant to be cut off, and the stem to be cut at any height above the ground that causes individual petioles to freely separate while maximizing the edible portion of the individual petioles. For example, the cutting device may be configured to remove the top portion and cut the celery plant above the stem at the same time to freely separate the individual petioles.

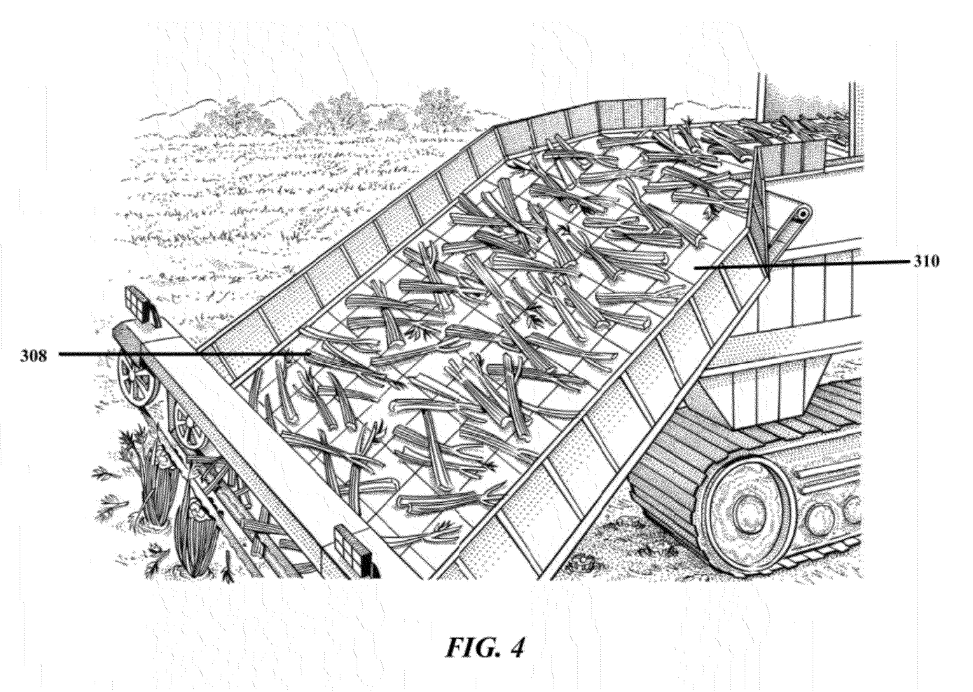

As depicted in FIG. 4, in the present exemplary embodiment, separated individual petioles 308 that are harvested from the ground fall onto belt 310, a 45-degree food grade conveyor belt attached to the harvesting machine. It should be recognized, however, that the angle of the conveyor belt may vary. Belt 310 may be supported by a bed, which may be as wide as or wider than the bed. The bed may have stainless steel guides on both sides to prevent separated individual petioles 308 from falling to the ground. One or more shakers may be attached to belt 310, which helps separate the individual petioles as they are transported on the belt. Belt 310 may carry separated individual petioles 308 upwards toward a processing station at the top of harvesting machine 302.

Conventional celery harvesting machines typically include gripping mechanisms to handle the entire celery head that is harvested from the ground, prior to releasing the head into a bin for transportation to a processing plant or moving the head into slicing/dicing stations. Since the process described above harvests the celery plant as freely separated, individual petioles, such gripping mechanisms needed for post-harvesting processing of entire celery heads are not necessary for harvesting machine 302. It should be understood, however, that the individual petioles may be held together and transported in a bundle to field workers at a processing station.

With reference again to FIG. 3A, at the top of harvesting machine 302 is washing station 312 station where a field worker manually selects and discards inedible portions of the celery product, such as inner yellow petioles, portions of the petioles that may have been affected by insects, or blackened petioles. The celery product then continues through washing station 312 to remove any soil or other debris that may be found on the harvested petioles. By washing the harvested petiole in the field, the fresh market celery is cleaned and re-hydrated prior to packing in order to maximize freshness.

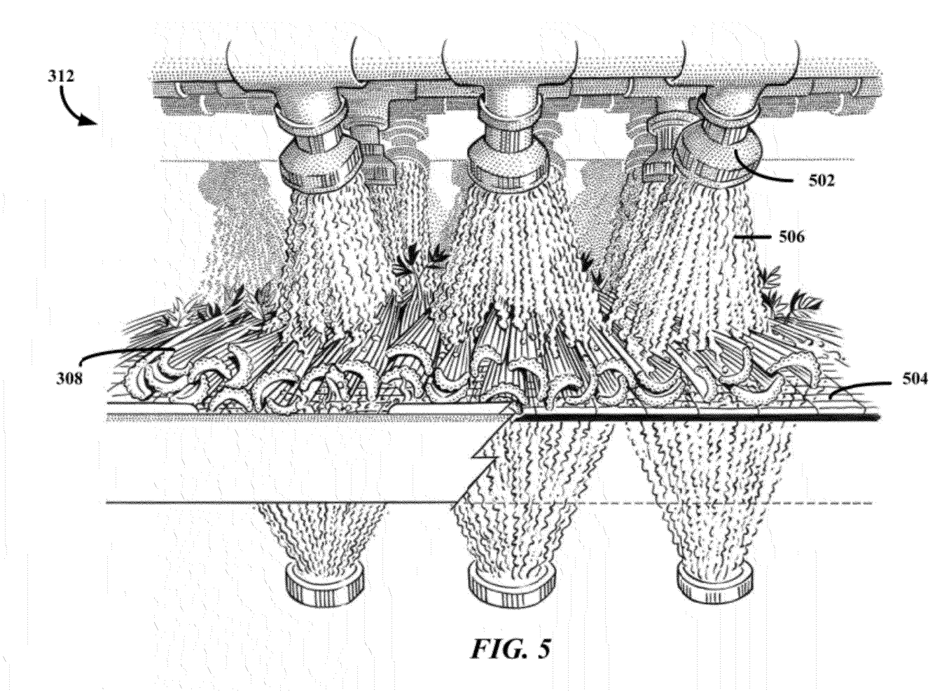

As depicted in FIG. 5, in the present exemplary embodiment, washing station 312 includes a plurality of pressurized shower heads 502 that spray the separated individual petioles 308 with chlorinated water 506. It should be recognized that the number and configuration of the shower heads may vary. In some embodiments, washing station 312 may employ 40 shower heads on the top and 40 shower heads on the bottom. Moreover, while chlorinated water 506 is used in the exemplary embodiment depicted in FIG. 5, other disinfecting solutions known in the art may be used. Washing the individual petioles within minutes after harvesting helps re-hydrate and refresh the product prior to be sleeved and packed, which helps maintain shelf life of the individual petioles sold in a package. While one of skill in the art might expect that eliminating the base of the celery stalk would reduce shelf life of the fresh market product, pre-washed full-length individual petioles have comparable shelf life to celery sold as whole heads in the fresh celery market. Belt 504 transports individual petioles 308 through washing station 312, and to the next processing station on harvesting machine 302.

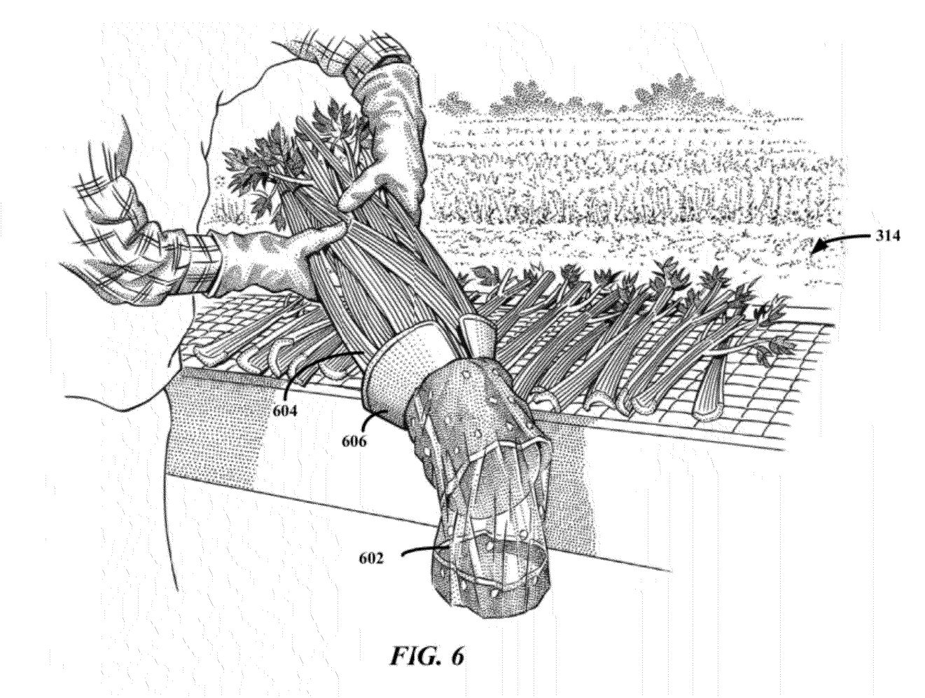

With reference again to FIG. 3A, the washed individual petioles are transported by conveyor belt to packaging station 314, where field workers on either side of the line package the washed individual petioles. As depicted in FIG. 6, in the present exemplary embodiment, a field worker takes washed individual petioles 604, and places the individual petioles through cone 606 into sleeve 602. It should be recognized, however, that field workers may package the individual petioles using any method known in the art, or a mechanized packaging method may be employed instead at packaging station 314.

With reference again to FIG. 3A, after washed individual petioles 604 are packaged into sleeves, a field worker at packing station 316 then places a plurality of the packaged sleeves into a cardboard box, which more commonly is referred to as a carton. Once a carton is filled, the cartons may be stacked onto a single pallet. After the product is packed into individual cartons and palletized, the palletized cartons may be transferred to a cooling facility. At the cooling facility, the palletized cartons will typically undergo a thorough cooling process. For example, hydro-cooling, vacuum cooling or hydro-vacuum cooling may be employed in the cooling process. The pallets containing the cooled finished product are then shipped to destination markets, where they are ultimately shipped to distributors, wholesalers, retailers, or other customers. By packaging individual petioles into a sleeve, the cooling process may be improved due to improved water and air flow through the sleeve, and because the heat-retaining core and under-sized yellow inner petioles remain in the field.

While FIG. 3A depicts field workers discarding inedible portions of the celery, packaging individual petioles into sleeves, and packing sleeves into cartons, respectively, it should be understood that the same worker may perform all or some of these steps. Moreover, while FIG. 3A depicts packaging of individual petioles into sleeves, and packing of sleeves into cartons performed in the field in which the celery was grown, it should be understood that one or more of these steps may be performed at processing facilities.

By cutting off the top portion of the celery plant and cutting the bottom portion above the stem, the celery plant is harvested as freely separated, full-length individual petioles that can readily be packaged as fresh market celery. The process described above maximizes the edible portion of the celery plant. In particular, the edible portion of the celery plant may include at least a portion of individual petioles 308 (FIG. 3B). In contrast, the inedible portion of the celery plant may include outer leaves 206 (FIG. 2), stem 208 (FIG. 2), inner yellow petioles, and any defective portions (e.g., portions of the petioles affected or destroyed by insects, blackened petioles). The inedible portions of the celery plant may either remain in the field in which the celery plant was harvested, or be discarded by field workers.

Additionally, by leaving inedible portions of the celery plant in the field, waste disposal costs by consumers are reduced because what would have been waste (e.g., base of the celery stalk, outer leaves, inner yellow petioles, blackened petioles) are left in the field. There is also a reduction in labor costs by consumers because of elimination of the need to separate the individual petioles from the stem, and to trim the outer leaves and defective petioles. Moreover, the waste portions, such as the base of the celery stalk, are typically the heavier portions of the celery plant. Thus, by reducing the packaging of these waste portions, the weight per sleeve is reduced, which in turn reduces hauling and handling costs. The reduction in weight per sleeve also translates to a reduction in weight per carton, with less gross weight per pallet and more usable net weight per pallet. This allows for placing more pallets per freight vehicle, thereby reducing shipping costs.

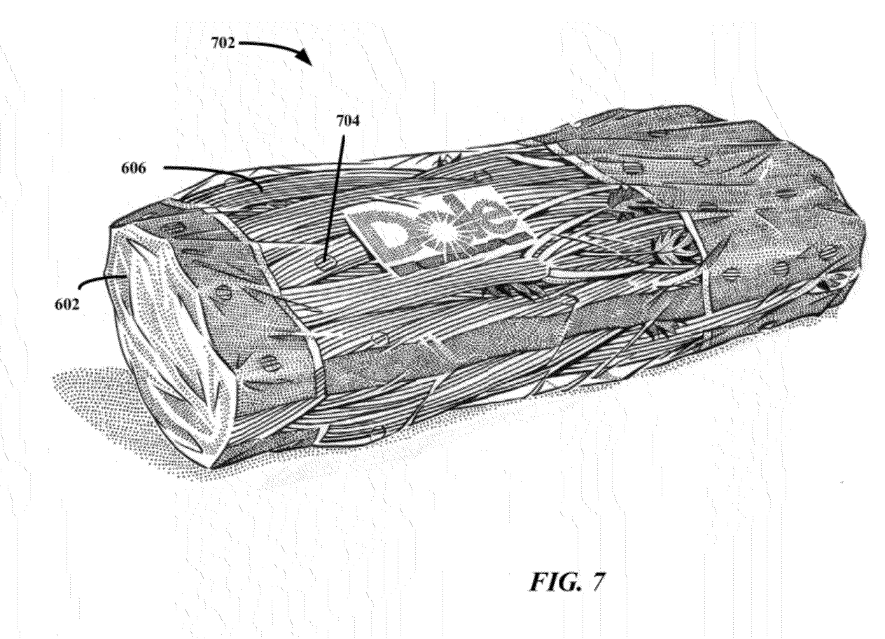

As depicted in FIG. 7, in an exemplary embodiment, packaged product 702 includes sleeve 602 and washed individual petioles 606. The number of individual celery petioles in a sleeve may vary. For example, sleeve 602 may contain anywhere from 10 to 25 individually separated and washed petioles. In the exemplary embodiment, 15 individually separated and washed petioles are placed into sleeve 602. By removing inedible portions of the individual petioles before packaging, the number of petioles per sleeve increases compared to the number of petioles attached at the stem of a whole head packaged into the sleeve. It should be also recognized that sleeve 602 may contain individual petioles obtained from different celery plants. The field worker in the harvesting and packaging process described above may have discretion in selecting the petioles packaged for commercial sale.

The weight of packaged product 702 may vary. For example, the packaged product may weigh between 1-5 pounds. In some embodiments, packaged product 702 has a weight of 1, 2, 3 or 4 pounds.

Sleeve 602 may be constructed of any material known in the art that is used for food packaging. In some embodiments, sleeve 602 may be formed from a plastic material. Exemplary plastic materials include, but are not limited to, low density polyethylene, linear low density polyethylene, high density polyethylene, polypropylene, butadiene, polystyrene, polyester, or any combination of these materials.

Furthermore, as depicted in FIG. 7, sleeve 602 has perforations 704 of ⅜ inch. The sleeve may have one or more perforations of any size and shape. The perforations may be visible to the naked eye or only under microscopic viewing. For example, perforations may be microperforations, or have a diameter of up to ½ inch.

The foregoing descriptions of specific embodiments have been presented for purposes of illustration and description. They are not intended to be exhaustive, and it should be understood that many modifications and variations are possible in light of the above teaching.

What is claimed is:

1. A method of commercially harvesting a celery plant in a field, the celery plant having a plurality of individual petioles, outer leaves, a stem, and roots extending from the stem when the celery plant is growing in the field, wherein the plurality of individual petioles are connected at the stem, wherein the leaves are attached to the petioles, wherein the celery plant has a top portion and a bottom portion, the method comprising:
a) removing the top portion of the celery plant to leave the bottom portion of the celery plant attached to the stem in the ground;
b) after performing step a), cutting the celery plant above the stem to separate the plurality of individual petioles;
c) washing the separated individual petioles;
d) packaging a plurality of washed individual petioles into a sleeve;
e) packing a plurality of sleeves into a carton;
f) shipping a plurality of cartons to one or more destination markets; and
g) shipping the plurality of cartons from the one or more destination markets to distributors, retailers, and other selling points,
wherein steps a)-c) are performed in the field in which the celery plant was grown.

2. The method of claim 1, wherein the top portion includes the outer leaves and the bottom portion includes the plurality of individual petioles connected at the stem.

3. The method of claim 2, wherein the outer leaves and stem remain in the field in which the celery plant was grown.

4. The method of claim 1, further comprising:
stacking a plurality of cartons on a pallet; and
cooling the pallet,
wherein the stacking is performed in the field in which the celery plant was grown, prior to shipping to one or more destination markets.

5. The method of claim 4, wherein the cooling employs hydro-cooling, vacuum cooling, or hydro-vacuum cooling.

6. The method of claim 1, wherein the celery plant is cut in step b) about ¼ to 1 inch above the ground.

7. The method of claim 1, wherein steps a) and b) are performed using a band saw.

8. The method of claim 1, wherein the separated individual petioles in step c) are washed with a solution comprising chlorine.

9. The method of claim 1, wherein the separated individual petioles in step c) are washed in a pressurized system.

10. The method of claim 1, wherein the washed individual petioles packaged in step d) are from different harvested celery plants.

11. A method of commercially harvesting a celery plant in a field, the celery plant having a plurality of individual petioles, outer leaves, a stem, and roots extending from the stem when the celery plant is growing in the field, wherein the plurality of individual petioles are connected at the stem, wherein the leaves are attached to the petioles, wherein the celery plant has a top portion and a bottom portion, the method comprising:
a) removing the top portion of the celery plant to leave the bottom portion of the celery plant attached to the stem in the ground;
b) after performing step a), cutting the celery plant above the stem to separate the plurality of individual petioles;
c) washing the separated individual petioles; and
d) packaging a plurality of washed individual petioles into a sleeve,
wherein steps a)-d) are performed in the field in which the celery plant was grown.

12. The method of claim 11, wherein the top portion includes the outer leaves and the bottom portion includes the plurality of individual petioles connected at the stem.

13. The method of claim 12, wherein the outer leaves and stem remain in the field in which the celery plant was grown.

14. The method of claim 11, wherein the celery plant is cut in step b) about ¼ to 1 inch above the ground.

15. The method of claim 11, wherein steps a) and b) are performed using a band saw.

16. The method of claim 11, wherein the separated individual petioles in step c) are washed with a solution comprising chlorine.

17. The method of claim 11, wherein the separated individual petioles in step c) are washed in a pressurized system.

18. The method of claim 11, wherein the washed individual petioles packaged in step d) are from different harvested celery plants.

19. The method of claim 11, wherein the washed individual petioles packaged in step d) are shipped to distributors, retailers, and other selling points.

20. The method of claim 11, further comprising:
packing a plurality of sleeves into a carton; and
cooling the carton.

21. The method of claim 20, wherein the cooling employs hydro-cooling, vacuum cooling, or hydro-vacuum cooling.

22. The method of claim 11, further comprising:
packing a plurality of sleeves into a carton.

23. The method of claim 22, further comprising:
stacking a plurality of cartons on a pallet.

24. A package of celery harvested and processed in the field, wherein the package comprises:
a sleeve; and
a plurality of individually separated petioles of a celery plant, wherein the celery plant has a plurality of individual petioles, outer leaves, a stem, and roots extending from the stem when the celery plant was grown in the field, wherein the plurality of individual petioles were connected at the stem, wherein the leaves were attached to the petioles, wherein the celery plant has a top portion and a bottom portion, and
wherein the top portion of the celery plant was removed to leave the bottom portion of the celery plant attached to the stem in the ground, the celery was cut above the stem to separate the plurality of individual petioles, the separated individual petioles were washed, and a plurality of washed individual petioles were packaged into the sleeve.

25. The package of claim 24, wherein the plurality of petioles were individually separated from different celery plants.

26. The package of claim 24, wherein the sleeve comprises a material selected from the group consisting of low density polyethylene, linear low density polyethylene, high density polyethylene, polypropylene, butadiene, polystyrene, polyester, and any combination thereof.

27. The package of claim 24, wherein the sleeve has one or more perforations.

28. The package of claim 27, wherein each perforation is a micro-perforation.

29. The package of claim 27, wherein each perforation has a diameter less than or equal to about ½ inch.
